(19) United States
(12) Patent Application Publication
(10) Pub. No.: US 2025/0293405 A1
(43) Pub. Date: Sep. 18, 2025

(54) Power Storage Cell and Method of Producing The Same

(71) Applicant: TOYOTA JIDOSHA KABUSHIKI KAISHA, Toyota-shi Aichi-ken (JP)

(72) Inventors: Yusuke KINTSU, Miyoshi-shi Aichi-ken (JP); Shinya ISHIKAWA, Anjo-shi Aichi-ken (JP); Takumi TANAKA, Toyota-shi Aichi-ken (JP); Masayoshi HAGA, Nagoya-shi Aichi-ken (JP); Kazuki MURAISHI, Toyota-shi Aichi-ken (JP); Yuji YAMASHITA, Toyota-shi Aichi-ken (JP); Aya SATO, Nagoya-shi Aichi-ken (JP)

(73) Assignee: TOYOTA JIDOSHA KABUSHIKI KAISHA, Toyota-shi Aichi-ken (JP)

(21) Appl. No.: 19/075,037

(22) Filed: Mar. 10, 2025

(30) Foreign Application Priority Data
Mar. 14, 2024 (JP) 2024-039817

(51) Int. Cl. H01M 50/533; H01M 50/15; H01M 50/528; H01M 50/538; H01M 50/548; H01M 50/627

(52) U.S. Cl. CPC H01M 50/533; H01M 50/15; H01M 50/528; H01M 50/538; H01M 50/548; H01M 50/627

(57) ABSTRACT

A power storage cell includes a case and an electrode stack. The case accommodates the electrode stack. The case includes a case body and a cap. The case body has an opening. The opening is closed by the cap. The cap has an electrode terminal provided thereto. The electrode stack is formed of a plurality of electrode sheets stacked together. Each of the plurality of the electrode sheets has a current-collecting tab. The plurality of the current-collecting tabs are stacked together to form a tab bundle. At at least part of the tab bundle, lengths of the plurality of the current-collecting tabs are different from one another. The tab bundle is bonded to the electrode terminal. Inside the case, the tab bundle is accommodated in a curved state.

### CROSS REFERENCE TO RELATED APPLICATIONS

This nonprovisional application is based on Japanese Patent Application No. 2024-039817 filed on Mar. 14, 2024, with the Japan Patent Office, the entire contents of which are hereby incorporated by reference.

### BACKGROUND OF THE DISCLOSURE

### Field of the Disclosure

The present disclosure relates to a power storage cell and a method of producing the same.

### Description of the Background Art

Japanese Patent Laying-Open No. 2001-283824 discloses a plurality of thin-rectangular current-collecting tabs connected to one portion of a terminal.

### SUMMARY OF THE DISCLOSURE

A power storage cell includes a case and a power generation element, for example. The case accommodates the power generation element. The power generation element may be a stack-type one, for example. A stack-type power generation element is also called an electrode stack. The electrode stack may be formed by stacking electrode sheets together. Each of the electrode sheets has a current-collecting tab at an end. As a result, at an end of the electrode stack, the current-collecting tabs are stacked together and a tab bundle is formed. As the number of the electrode sheets stacked together increases, the volume of the tab bundle may also increase. The tab bundle does not contribute to battery capacity. As the tab bundle takes up more space inside the case, the power storage cell may have less energy density.

An object of the present disclosure is to reduce space taken up by a tab bundle.

Hereinafter, the technical configuration and effects of the present disclosure will be described. It should be noted that the action mechanism includes presumption. The action mechanism does not limit the technical scope of the present disclosure.
1. A power storage cell includes a case and an electrode stack. The case accommodates the electrode stack. The case includes a case body and a cap. The case body has an opening. The opening is closed by the cap. The cap has an electrode terminal provided thereto. The electrode stack is formed of a plurality of electrode sheets stacked together. Each of the plurality of the electrode sheets has a current-collecting tab. The plurality of the current-collecting tabs are stacked together to form a tab bundle. At at least part of the tab bundle, lengths of the plurality of the current-collecting tabs are different from one another. The tab bundle is bonded to the electrode terminal. Inside the case, the tab bundle is accommodated in a curved state.

In the power storage cell according to “1” above, the lengths of the current-collecting tabs are not uniform. When the lengths of the current-collecting tabs are made different from one another, the tab bundle (an assembly of the current-collecting tabs) in a curved state may have less volume. In other words, the tab bundle may take up less space inside the case.
2. The power storage cell according to “1” above may include the following configuration, for example. The lengths of the current-collecting tabs decrease sequentially from an outer circumferential side of a curve of the tab bundle toward an inner circumferential side of the curve.

When the lengths of the current-collecting tabs decrease sequentially from the outer circumferential side of the curve toward the inner circumferential side of the curve, the tab bundle may be bent small. In other words, the tab bundle is expected to take up less space.
3. The power storage cell according to “1” above may include the following configuration, for example. At an intermediate position between an outer circumferential side of a curve of the tab bundle and an inner circumferential side of the curve, a current-collecting tab that is the longest among the plurality of the current-collecting tabs is positioned.

When the current-collecting tab present at an intermediate position in the tab bundle is long, heat dissipation is expected to be enhanced. With enhanced heat dissipation, unevenness in temperature in the power storage cell is expected to be reduced.
4. The power storage cell according to any one of “1” to “3” above may include the following configuration, for example. Each of the plurality of the current-collecting tabs has a cut end face at a tip thereof closer to the electrode terminal. In a state where the tab bundle and the electrode terminal are separated from each other and each of the plurality of the current-collecting tabs is stretched in a length direction, the plurality of the cut end faces are not aligned with each other.
5. The power storage cell according to any one of “1” to “4” above may include the following configuration, for example. The plurality of the current-collecting tabs are tied together to form the tab bundle. Each of the plurality of the current-collecting tabs has a cut end face at a tip thereof closer to the electrode terminal. In a state where the tab bundle is bonded to the electrode terminal, at a tip of the tab bundle, the plurality of the cut end faces are aligned with each other.

When the lengths of the current-collecting tabs are different from one another, the plurality of the cut end faces may be not aligned with each other as in “4” above. The current-collecting tabs (the tab bundle) may be bonded to the electrode terminal after the current-collecting tabs are assembled together with the cut end faces aligned with each other.
6. The power storage cell according to any one of “1” to “5” above may include the following configuration, for example. The tab bundle includes a first tab bundle and a second tab bundle. At at least part of the first tab bundle, the lengths of the plurality of the current-collecting tabs are different from one another. At at least part of the second tab bundle, the lengths of the plurality of the current-collecting tabs are different from one another. Both the first tab bundle and the second tab bundle are connected to the same electrode terminal. Inside the case, each of the first tab bundle and the second tab bundle is curved. The cap has a liquid inlet provided thereto. An axis of the liquid inlet lies between the first tab bundle and the second tab bundle.

At one of the electrodes, the tab bundle may be divided in two parts. When the liquid inlet is provided in such a manner that an electrolyte solution can pass between these two tab bundles thus divided, permeation of the electrolyte solution into the electrode stack is expected to be facilitated.
7. The power storage cell according to any one of “1” to “6” above may include the following configuration, for example. When viewed in a plane, each of the plurality of the current-collecting tabs has an end part with a projected portion.

With each current-collecting tab having an end part with a projected portion, the tab bundle may have less volume.
8. The power storage cell according to any one of “1” to “7” above may include the following configuration, for example. A thickness of the cap is smaller than a minimum diameter of the opening.

With the thickness of the cap being smaller than the minimum diameter of the opening of the case body, in a production method according to “14” below, for example, the cap bonded to the electrode stack may be inserted into the case body, together with the electrode stack. When the cap is also inserted in the case body, the tab bundle and the electrode terminal may be bonded together even when the tab bundle is short.
9. A method of producing a power storage cell comprises (a) to (e) below:
(a) preparing electrode sheets each having a current-collecting tab;
(b) cutting off a part of the current-collecting tab to adjust a length of the current-collecting tab;
(c) forming an electrode stack having a tab bundle by stacking the electrode sheets together;
(d) inserting the electrode stack into a case; and
(e) bonding the tab bundle to an electrode terminal.

The tab bundle is formed of the current-collecting tabs stacked together. Inside the case, the tab bundle is accommodated in a curved state. The (b) includes cutting off a part of the current-collecting tab so that the lengths of the plurality of the current-collecting tabs are different from one another at at least part of the tab bundle.

With a part of the current-collecting tab cut off in advance before formation of the electrode stack, the tab bundle may have less volume. In other words, the tab bundle may take up less space. Further, the small volume of the tab bundle may sometimes make it easier to place the tab bundle to one side within the case, for example. With the tab bundle placed to one side within the case, the space is expected to be used effectively. Further, with the tab bundle placed to one side, electrolyte solution is expected to be injected without being interfered by the tab bundle, for example.

In the case where a part of the current-collecting tab is cut off after formation of the electrode stack, cutting chips can enter into the electrode stack. Further, as the number of stacking in the electrode stack increases, it can become more difficult to adjust the length of the individual current-collecting tabs by cutting.
10. The method of producing a power storage cell according to “9” above may include the following configuration, for example. The (b) includes cutting off the part of the current-collecting tab so that the lengths of the current-collecting tabs decrease sequentially from an outer circumferential side of a curve of the tab bundle toward an inner circumferential side of the curve.

By the production method according to “10” above, the power storage cell according to “2” above may be produced, for example.
11. The method of producing a power storage cell according to “9” above may include the following configuration, for example. The (b) includes cutting off the part of the current-collecting tab so that a current-collecting tab that is the longest among the plurality of the current-collecting tabs is positioned at an intermediate position between an outer circumferential side of a curve of the tab bundle and an inner circumferential side of the curve.

By the production method according to “11” above, the power storage cell according to “3” above may be produced, for example.

12. The method of producing a power storage cell according to any one of “9” to “11” above may include the following configuration, for example. As a result of cutting off the part of the current-collecting tab, a cut end face is formed. The (c) includes forming the tab bundle by tying the plurality of the current-collecting tabs together in a state where the current-collecting tabs are stacked together with the plurality of the cut end faces being aligned with each other.

By the production method according to “12” above, the power storage cell according to “5” above may be produced, for example.
13. The method of producing a power storage cell according to any one of “9” to “12” above may include the following configuration, for example. The case includes a case body in a tubular shape, a first cap, and a second cap. The case body has a first opening at one end in an axial direction and a second opening at the other end in the axial direction. The first cap is configured to close the first opening. The second cap is configured to close the second opening. The first cap has a positive electrode terminal provided thereto. The second cap has a negative electrode terminal provided thereto. The electrode stack includes a positive electrode tab bundle and a negative electrode tab bundle. In an orthogonal direction that is orthogonal to a stacking direction of the electrode sheets, each of the positive electrode tab bundle and the negative electrode tab bundle protrudes outwardly. In the orthogonal direction, the negative electrode tab bundle and the positive electrode tab bundle protrude in opposite directions. The electrode stack is inserted in the case body in such a manner that the orthogonal direction lies parallel to the axial direction. The positive electrode terminal is bonded to the positive electrode tab bundle to achieve a positional relationship where a protruding portion of the positive electrode tab bundle protruding from the first opening is larger in the axial direction than a protruding portion of the negative electrode tab bundle protruding from the second opening.

When the electrode stack is located at a position deviated from the center of the case body, the positive electrode tab bundle may be bonded to the positive electrode terminal even if the positive electrode tab bundle is short, for example. With the positive electrode tab bundle being short, the positive electrode tab bundle may take up less space.
14. The method of producing a power storage cell according to “13” above may include the following configuration, for example. After the positive electrode tab bundle and the positive electrode terminal are bonded together, the electrode stack is slid in a direction opposite to a direction in which the electrode stack is inserted. The negative electrode terminal is bonded to the negative electrode tab bundle to achieve a positional relationship where the protruding portion of the negative electrode tab bundle protruding from the second opening is larger in the axial direction than the protruding portion of the positive electrode tab bundle protruding from the first opening.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view illustrating an example of a first power storage cell according to the present embodiment.

FIG. 2 is a schematic cross-sectional view illustrating an example of a first power storage cell according to the present embodiment.

FIG. 3 is a first schematic cross-sectional view illustrating an example of an electrode stack according to the present embodiment.

FIG. 4 is a second schematic cross-sectional view illustrating an example of an electrode stack according to the present embodiment.

FIG. 5 is a schematic view illustrating an example of a method to tie a tab bundle according to the present embodiment.

FIG. 6 is a schematic view illustrating an example of a method to tie a tab bundle according to a reference embodiment.

FIG. 7 is a first schematic plan view illustrating an example of electrode sheets.

FIG. 8 is a second schematic plan view illustrating an example of electrode sheets.

FIG. 9 is a schematic view illustrating an example of a second power storage cell according to the present embodiment.

FIG. 10 is a schematic view illustrating an example of an electrode stack according to the present embodiment.

FIG. 11 is a schematic cross-sectional view illustrating an example of a second power storage cell according to the present embodiment.

FIG. 12 is a schematic flowchart illustrating a method of producing a power storage cell according to the present embodiment.

FIG. 13 is a schematic plan view illustrating an example of (b) cutting a current-collecting tab according to the present embodiment.

FIG. 14 is a first schematic cross-sectional view illustrating an example of (d) inserting into a case and (e) bonding a tab bundle to a terminal according to the present embodiment.

FIG. 15 is a second schematic cross-sectional view illustrating an example of (d) inserting into a case and (e) bonding a tab bundle to a terminal according to the present embodiment.

### DESCRIPTION OF THE EMBODIMENTS

### Terms

Terms such as “comprise”, “include”, and “have”, and other similar terms are open-ended terms. In an open-ended term, in addition to a component, an additional component may or may not be further included. The term “consist of” is a closed-end term. However, even in a configuration that is expressed by a closed-end term, impurities present under ordinary circumstances as well as an additional element irrelevant to the technique of interest may be included. The term “consist essentially of” is a semiclosed-end term. A semiclosed-end term tolerates addition of an element that does not substantially affect the fundamental, novel features of the technique of interest.

Expressions such as “may” and “can” are not intended to mean “must” (obligation) but rather mean “there is a possibility” (tolerance).

Regarding a plurality of steps, operations, processes, and the like that are included in different methods, the order for implementing those things is not limited to the described order, unless otherwise specified. For example, a plurality of steps may proceed simultaneously. For example, a plurality of steps may be implemented in reverse order.

Any geometric term should not be interpreted solely in its exact meaning. Examples of geometric terms include “parallel”, “vertical”, “orthogonal”, and the like. For example, as long as substantially the same or similar functions are obtained, the relative direction, angle, distance, and the like may vary. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. A part of a given configuration may have been omitted.

A singular form may also include its plural meaning, unless otherwise specified. For example, “a current-collecting tab” may mean a plurality of current-collecting tabs (a group of current-collecting tabs).

The expression “when viewed in a plane” refers to when a target object is viewed in a direction parallel to the thickness direction of the target object. The shape of the target object when viewed in a plane is shown in a plan view.

“Power storage cell” refers to a battery that is rechargeable. A power storage cell may be a lithium-ion battery, for example. A power storage cell may include a liquid electrolyte (an electrolyte solution), a gelled electrolyte, or a solid electrolyte, for example. “Electrode” collectively refers to a positive electrode and a negative electrode. Similarly, “electrode terminal” collectively refers to a positive electrode terminal and a negative electrode terminal, for example. “Current-collecting tab” collectively refers to a positive electrode current-collecting tab and a negative electrode current-collecting tab. “Tab bundle” collectively refers to a positive electrode tab bundle and a negative electrode tab bundle. “Tab bundle” also collectively refers to a first tab bundle and a second tab bundle.

The expression “curved” refers to any possible state except straight. “Curved” includes a bent state, for example. In a state where the target object is curved, the target object may or may not include a curved surface.

### First Power Storage Cell

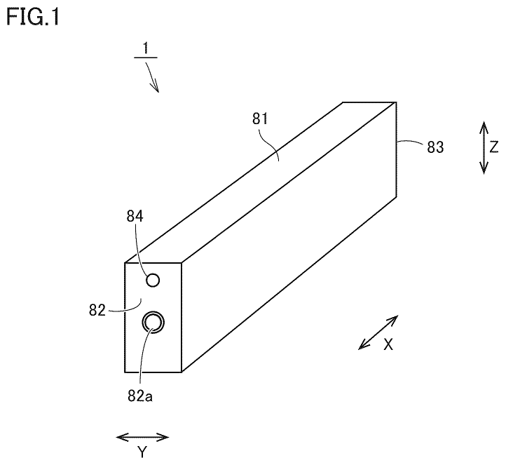

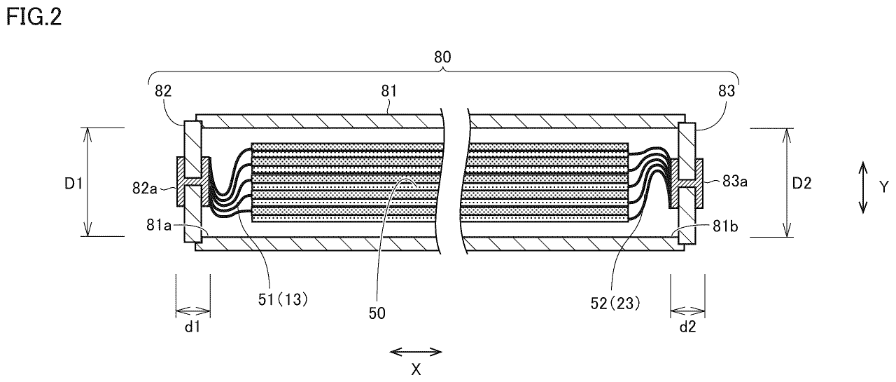

FIG. 1 is a schematic view illustrating an example of a first power storage cell according to the present embodiment. FIG. 2 is a schematic cross-sectional view illustrating an example of a first power storage cell according to the present embodiment. A first power storage cell 1 includes a case 80 and an electrode stack 50. Case 80 includes electrode stack 50. Case 80 includes a case body 81 and a cap.

### Case Body

The outer shape of case body 81 may be a rectangular parallelepiped, for example. The outer shape of case body 81 may be a long plate, for example. The width of case body 81 is the outer dimension in the X direction. The width of case body 81 may be 500 mm or more, or 750 mm or more, or 1000 mm or more, for example. The width of case body 81 may be 2000 mm or less, or 1500 mm or less, or 1250 mm or less, for example. The height of case body 81 is the outer dimension in the Z direction. The height of case body 81 may be 50 mm or more, or 75 mm or more, or 100 mm or more, for example. The height of case body 81 may be 200 mm or less, or 150 mm or less, or 125 mm or less, or 100 mm or less, for example. The thickness of case body 81 is the outer dimension in the Y direction. The thickness of case body 81 may be 5 mm or more, or 10 mm or more, or 15 mm or more, or 20 mm or more, for example. The thickness of case body 81 may be 30 mm or less, or 25 mm or less, or 20 mm or less, or 15 mm or less, or 10 mm or less. The ratio of width to height may be from 5 to 20, for example. The ratio of width to thickness may be from 50 to 200, for example.

Case body 81 has an opening. Case body 81 may have a first opening 81a and a second opening 81b, for example. In other words, case body 81 may be in the shape of a tube. For example, case body 81 may be in the shape of a cylindrical prism. First opening 81a may be at one end in the axial direction (the X direction). Second opening 81b may be at the other end in the axial direction.

### Cap

The opening is closed by the cap. There may be only one cap, or may be a plurality of caps. The number of caps corresponds to the number of openings of case body 81. For example, case 80 may include a first cap 82 and a second cap 83. For example, first opening 81a may be closed by first cap 82. For example, second opening 81b may be closed by second cap 83. The cap has an electrode terminal provided thereto. For example, first cap 82 may have a positive electrode terminal 82a provided thereto. For example, positive electrode terminal 82a may be electrically separated from first cap 82 by an electrically-insulating member (not illustrated). For example, second cap 83 may have a negative electrode terminal 83a provided thereto. One cap may have one electrode terminal. One cap may have a plurality of electrode terminals. When one cap has a plurality of electrode terminals, the polarities of the plurality of electrode terminals may be the same as or different from each other. For example, the cap may have a liquid inlet 84 provided thereto. For example, first cap 82 may have liquid inlet 84 provided thereto.

For example, the thickness (d1) of first cap 82 may be smaller than the minimum diameter (D1) of first opening 81a. The thickness (d1) of first cap 82 includes the thickness of positive electrode terminal 82a. “Minimum diameter” refers to the smallest inner diameter among all the inner diameters of the opening. For example, the relationship of “d1≤0.9×D1”, “d1≤0.8×D1”, “d1≤0.7×D1”, “d1≤0.6×D1”, “d1≤0.5×D1”, or the like may be satisfied. For example, the relationship of “0.1D1≤d1”, “0.2D1≤d1”, “0.3D1≤d1”, “0.4D1≤d1”, “0.5D1≤d1”, or the like may be satisfied.

For example, the thickness (d2) of second cap 83 may be smaller than the minimum diameter (D2) of second opening 81b. The thickness (d2) of second cap 83 includes the thickness of negative electrode terminal 83a. For example, the relationship of “D1=D2” may be satisfied. For example, the relationship of “d1=d2” may be satisfied.

### Electrode Stack

Electrode stack 50 has a tab bundle. For example, electrode stack 50 may have a positive electrode tab bundle 51 and a negative electrode tab bundle 52. “Tab bundle” is a stack of current-collecting tabs. Positive electrode tab bundle 51 is formed of positive electrode current-collecting tabs 13 stacked together. Negative electrode tab bundle 52 is formed of negative electrode current-collecting tabs 23 stacked together. Inside case 80, each of positive electrode tab bundle 51 and negative electrode tab bundle 52 is accommodated in a curved state. Positive electrode tab bundle 51 is bonded to positive electrode terminal 82a. Negative electrode tab bundle 52 is bonded to negative electrode terminal 83a.

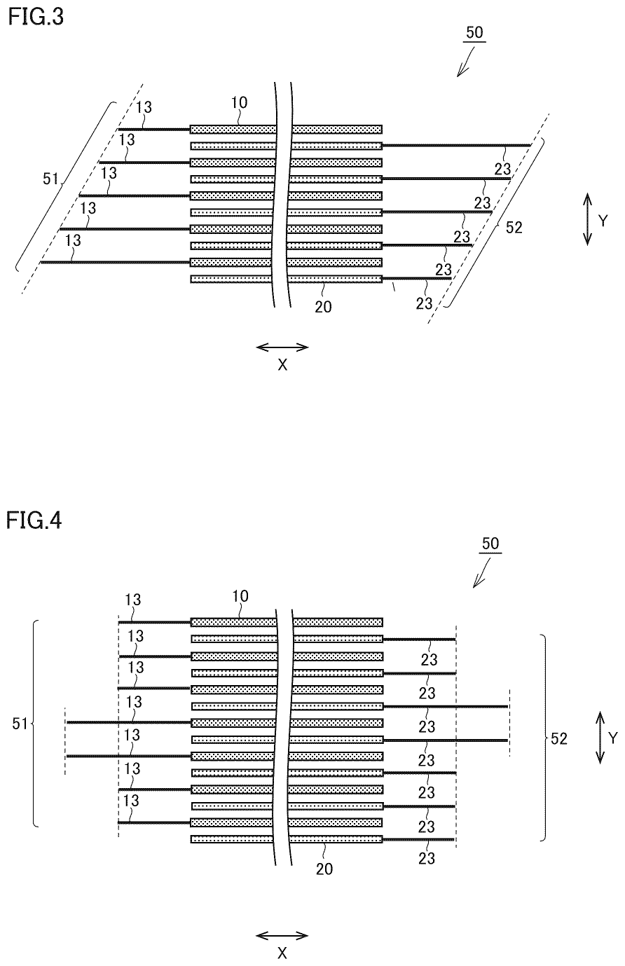

FIG. 3 is a first schematic cross-sectional view illustrating an example of an electrode stack according to the present embodiment. Electrode stack 50 includes a plurality of electrode sheets. Electrode stack 50 may include 3 to 100 electrode sheets, for example. Electrode stack 50 is formed by alternately stacking a positive electrode sheet 10 and a negative electrode sheet 20. In other words, electrode stack 50 is formed of a plurality of electrode sheets stacked together. Between positive electrode sheet 10 and negative electrode sheet 20, a separator (not illustrated) may be interposed. Each of a plurality of positive electrode sheets 10 has positive electrode current-collecting tab 13. Each of a plurality of negative electrode sheets 20 has negative electrode current-collecting tab 23. Positive electrode current-collecting tab 13 and negative electrode current-collecting tab 23 may be placed in such a manner that they protrude outwardly in the X direction. The X direction is a direction that is orthogonal to the stacking direction (the Y direction). In the X direction, negative electrode current-collecting tab 23 and positive electrode current-collecting tab 13 may protrude in opposite directions.

At least one of positive electrode tab bundle 51 and negative electrode tab bundle 52 has a part where the lengths of the current-collecting tabs are different from one another. Only one of positive electrode tab bundle 51 and negative electrode tab bundle 52 may have a part where the lengths of the current-collecting tabs are different from one another. Each of positive electrode tab bundle 51 and negative electrode tab bundle 52 may have a part where the lengths of the current-collecting tabs are different from one another.

For example, at at least part of positive electrode tab bundle 51, the lengths of a plurality of positive electrode current-collecting tabs 13 may be different from one another. For example, all the positive electrode current-collecting tabs 13 may have different lengths from one another. For example, the lengths of positive electrode current-collecting tabs 13 may gradually decrease. For example, the lengths of positive electrode current-collecting tabs 13 may decrease sequentially from the outer circumferential side of the curve of positive electrode tab bundle 51 toward the inner circumferential side of the curve. The difference in length between adjacent positive electrode current-collecting tabs 13 may be from 1 to 10 mm, for example. As for positive electrode tab bundle 51 in FIG. 3 and FIG. 4, the lower side in the figure is the outer circumferential side of the curve, and the upper side in the figure is the inner circumferential side of the curve.

For example, at at least part of negative electrode tab bundle 52, the lengths of a plurality of negative electrode current-collecting tabs 23 may be different from one another. For example, all the negative electrode current-collecting tabs 23 may have different lengths from one another. For example, the lengths of negative electrode current-collecting tabs 23 may gradually decrease. For example, the lengths of negative electrode current-collecting tabs 23 may decrease sequentially from the outer circumferential side of the curve of negative electrode tab bundle 52 toward the inner circumferential side of the curve. The difference in length between adjacent negative electrode current-collecting tabs 23 may be from 1 to 10 mm, for example. As for negative electrode tab bundle 52 in FIG. 3 and FIG. 4, the lower side in the figure is the inner circumferential side of the curve, and the upper side in the figure is the outer circumferential side of the curve.

FIG. 4 is a second schematic cross-sectional view illustrating an example of an electrode stack according to the present embodiment. For example, some of positive electrode current-collecting tabs 13 may have different lengths from one another. For example, at an intermediate position between the outer circumferential side of the curve of positive electrode tab bundle 51 and the inner circumferential side of the curve, a positive electrode current-collecting tab 13 that is the longest among the plurality of positive electrode current-collecting tabs 13 may be positioned. “Intermediate position” refers to a point between the outer-most side of the curve and the inner-most side of the curve, for example. “Intermediate position” may be the midpoint between the outer-most side of the curve and the inner-most side of the curve. The number of the longest positive electrode current-collecting tab 13 may be only one, or may be more than one. The difference between the maximum length and the minimum length of positive electrode current-collecting tabs 13 may be from 1 to 10 mm, for example.

For example, some of negative electrode current-collecting tabs 23 may have different lengths from one another. For example, at an intermediate position between the outer circumferential side of the curve of negative electrode tab bundle 52 and the inner circumferential side of the curve, a negative electrode current-collecting tab 23 that is the longest among the plurality of negative electrode current-collecting tabs 23 may be positioned. The number of the longest negative electrode current-collecting tab 23 may be only one, or may be more than one. The difference between the maximum length and the minimum length of negative electrode current-collecting tabs 23 may be from 1 to 10 mm, for example.

FIG. 5 is a schematic view illustrating an example of a method to tie a tab bundle according to the present embodiment. Each of the plurality of positive electrode current-collecting tabs 13 may have a cut end face 13b at one of the tips thereof that is closer to positive electrode terminal 82a. Cut end face 13b may be formed by cutting off the tip of positive electrode current-collecting tab 13. In FIG. 5, positive electrode tab bundle 51 and positive electrode terminal 82a are separated from each other and each of the plurality of positive electrode current-collecting tabs 13 is stretched in the length direction. In this state, the plurality of cut end faces 13b may be not aligned with each other. For example, the plurality of cut end faces 13b may be not aligned with each other when positive electrode current-collecting tabs 13 are cut individually. Among the plurality of cut end faces 13b, all the cut end faces 13b may be not aligned with each other. Among the plurality of cut end faces 13b, only some cut end faces 13b may be not aligned with each other.

The plurality of positive electrode current-collecting tabs 13 may be tied together to form positive electrode tab bundle 51. The method to tie them together is not particularly limited. For example, the plurality of positive electrode current-collecting tabs 13 may be tied together by ultrasonic bonding. For example, the plurality of positive electrode current-collecting tabs 13 may be stacked together in such a manner that the plurality of cut end faces 13b are aligned with each other at the tip of positive electrode tab bundle 51, to form a stack. The resulting stack is held between an ultrasonic horn 201 and an anvil 202. Ultrasonic waves are applied to the stack, and thereby the plurality of positive electrode current-collecting tabs 13 may become tied together. Thus, positive electrode tab bundle 51 may be formed. Positive electrode tab bundle 51 thus tied may be bonded to positive electrode terminal 82a. In this way, in a state where positive electrode tab bundle 51 is bonded to positive electrode terminal 82a, the plurality of cut end faces 13b may be aligned with each other at the tip of positive electrode tab bundle 51. Negative electrode tab bundle 52 may also be formed in the same manner as for positive electrode tab bundle 51. The plurality of current-collecting tabs may be tied together at the same time they are bonded to the electrode terminal.

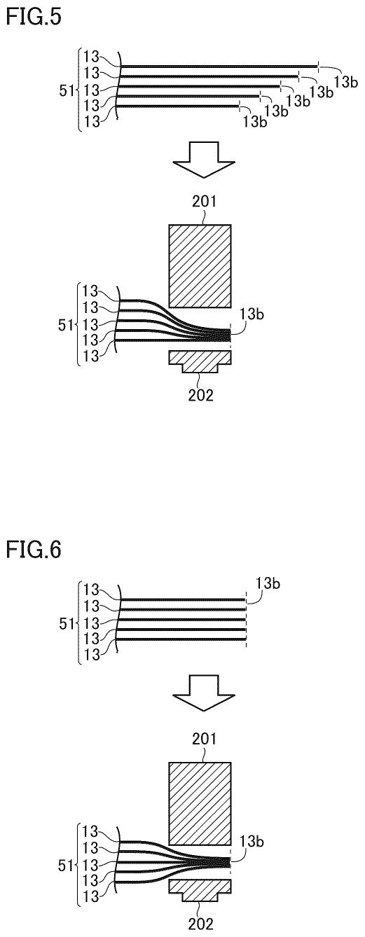

FIG. 6 is a schematic view illustrating an example of a method to tie a tab bundle according to a reference embodiment. Also in FIG. 6, positive electrode tab bundle 51 and positive electrode terminal 82a are separated from each other and each of the plurality of positive electrode current-collecting tabs 13 is stretched in the length direction. In this state, the plurality of cut end faces 13b are aligned with each other. This is because conventionally the plurality of positive electrode current-collecting tabs 13 have the same length. Alternatively, it is because the plurality of positive electrode current-collecting tabs 13 are cut together. When the plurality of positive electrode current-collecting tabs 13 with the same length are tied together, positive electrode tab bundle 51 may have more volume. For example, in positive electrode tab bundle 51, positive electrode current-collecting tabs 13 may be warped. A warped positive electrode current-collecting tab 13 can take up more space.

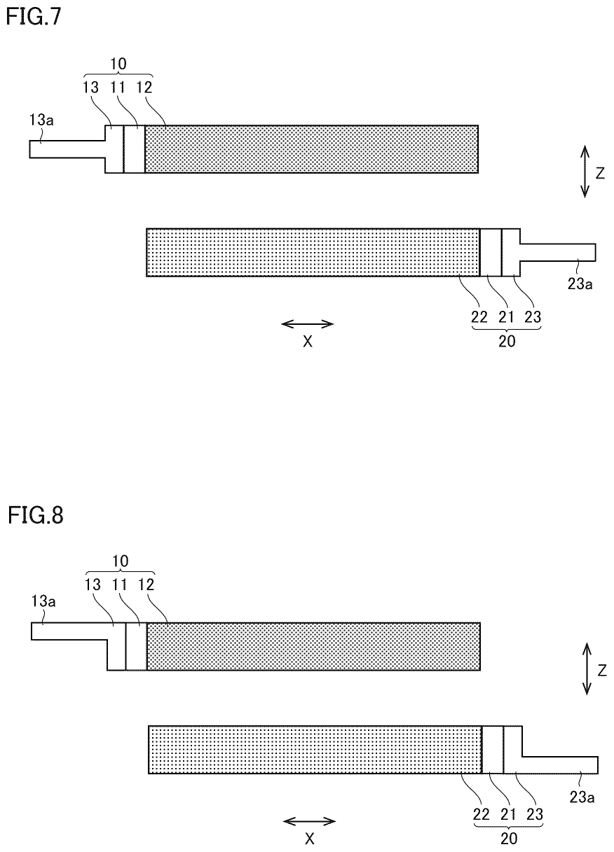

FIG. 7 is a first schematic plan view illustrating an example of electrode sheets. Positive electrode sheet 10 may include a positive electrode current collector 11 and a positive electrode active material layer 12. Positive electrode current collector 11 may include aluminum foil and/or the like, for example. Positive electrode active material layer 12 may be formed by applying a positive electrode active material and/or the like to the surface of positive electrode current collector 11. The positive electrode active material may include lithium iron phosphate, lithium-nickel composite oxide, and/or the like, for example.

The planar shape of positive electrode sheet 10 may be a long rectangular, for example. The planar shape of positive electrode sheet 10 may be a belt-like shape, for example. Positive electrode sheet 10 may have positive electrode current-collecting tab 13 at an end in the length direction (the X direction), for example. Positive electrode current-collecting tab 13 may be a thin component, for example. For example, the thin positive electrode current-collecting tab 13 may be bonded to positive electrode current collector 11. Positive electrode current-collecting tab 13 may be, for example, a part of positive electrode current collector 11. For example, positive electrode current-collecting tab 13 may be formed by cutting off a part of positive electrode current collector 11.

When viewed in a plane, positive electrode current-collecting tab 13 may have an end part 13a with a projected portion. The shape “with a projected portion” refers to a shape where the dimension of the tip in the width direction (the Z direction) is smaller. End part 13a may be located at the center in the width direction, for example. FIG. 8 is a second schematic plan view illustrating an example of electrode sheets. End part 13a may be located at one side in the width direction, for example.

As illustrated in FIG. 7 and FIG. 8, negative electrode sheet 20 may have a similar structure to positive electrode sheet 10. Negative electrode sheet 20 may include a negative electrode current collector 21, a negative electrode active material layer 22, and negative electrode current-collecting tab 23. Negative electrode current collector 21 may include copper foil and/or the like, for example. Negative electrode active material layer 22 may be formed by applying a negative electrode active material and/or the like to the surface of negative electrode current collector 21. The negative electrode active material may include graphite, silicon oxide, silicon, and/or the like, for example. Negative electrode current-collecting tab 23 may also have an end part 23a with a projected portion. The area of negative electrode sheet 20 may be larger than that of positive electrode sheet 10. For example, the area of negative electrode active material layer 22 may be larger than that of positive electrode active material layer 12. The area ratio of negative electrode active material layer 22 to positive electrode active material layer 12 may be from 1.01 to 1.10, for example.

### Second Power Storage Cell

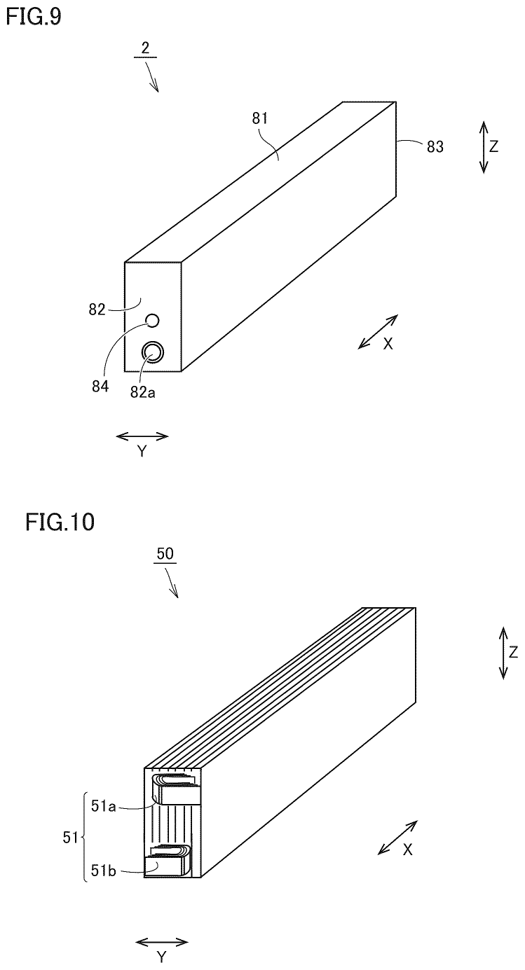

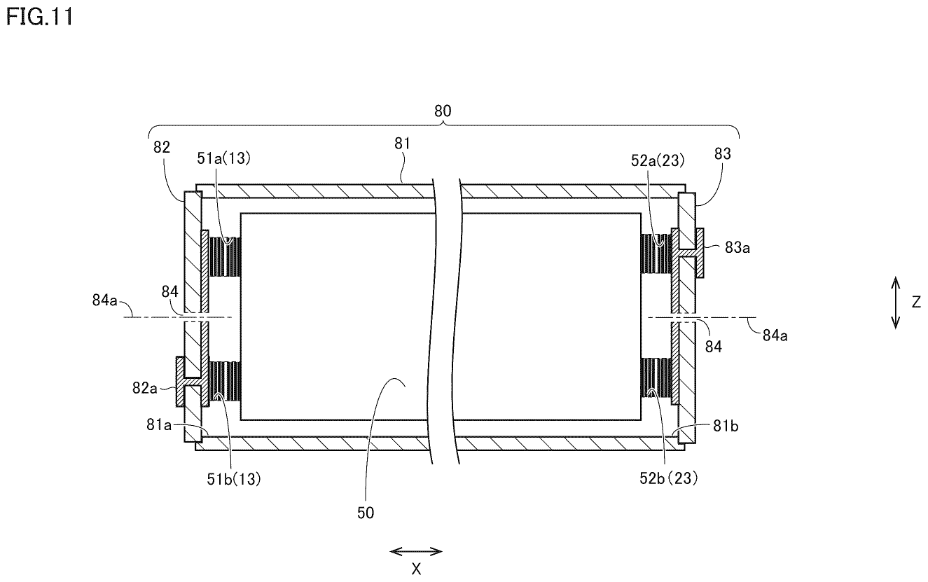

FIG. 9 is a schematic view illustrating an example of a second power storage cell according to the present embodiment. FIG. 10 is a schematic view illustrating an example of an electrode stack according to the present embodiment. FIG. 11 is a schematic cross-sectional view illustrating an example of a second power storage cell according to the present embodiment. Basically, the below description only explains the differences between a second power storage cell 2 and first power storage cell 1. For example, the tab bundle may be divided in two parts. In other words, positive electrode tab bundle 51 may include a first tab bundle 51a and a second tab bundle 51b. At at least part of first tab bundle 51a, the lengths of the plurality of positive electrode current-collecting tabs 13 are different from one another. Also, at at least part of second tab bundle 51b, the lengths of the plurality of positive electrode current-collecting tabs 13 are different from one another. First tab bundle 51a and second tab bundle 51b are connected to positive electrode terminal 82a. That is, both the first tab bundle 51a and the second tab bundle 51b are connected to the same electrode terminal. For example, the tab bundle may be divided in three or more parts. For example, similarly, negative electrode tab bundle 52 may include a first tab bundle 52a and a second tab bundle 52b.

Inside case 80, both the first tab bundle 51a and the second tab bundle 51b are curved. For example, as illustrated in FIG. 10, first tab bundle 51a and second tab bundle 51b may be curved in opposite directions. For example, first tab bundle 51a and second tab bundle 51b may be curved in the same direction.

In FIG. 11, first cap 82 has liquid inlet 84 provided thereto. An axis 84a of liquid inlet 84 lies between first tab bundle 51a and second tab bundle 51b. The electrolyte solution may permeate into electrode stack 50 along axis 84a. In other words, the electrolyte solution may permeate into electrode stack 50 without being interfered by first tab bundle 51a or second tab bundle 51b. For example, first tab bundle 51a and second tab bundle 51b may be curved in a direction away from axis 84a of liquid inlet 84.

Second cap 83 may also have liquid inlet 84 provided thereto. Similarly to first cap 82, axis 84a of liquid inlet 84 of second cap 83 may lie between first tab bundle 52a and second tab bundle 52b. For example, liquid inlet 84 may be located at the center of the cap in the Z direction. For example, positive electrode terminal 82a may alternate with negative electrode terminal 83a in the Z direction. For example, at first cap 82, positive electrode terminal 82a may be located below liquid inlet 84 in the Z direction. For example, at second cap 83, negative electrode terminal 83a may be located above liquid inlet 84 in the Z direction. For example, the electrolyte solution may be injected through both liquid inlets 84. For example, the electrolyte solution may be injected through one of the liquid inlets 84 and degassing may be performed through the other liquid inlet 84.

### Method of Producing Power Storage Cell

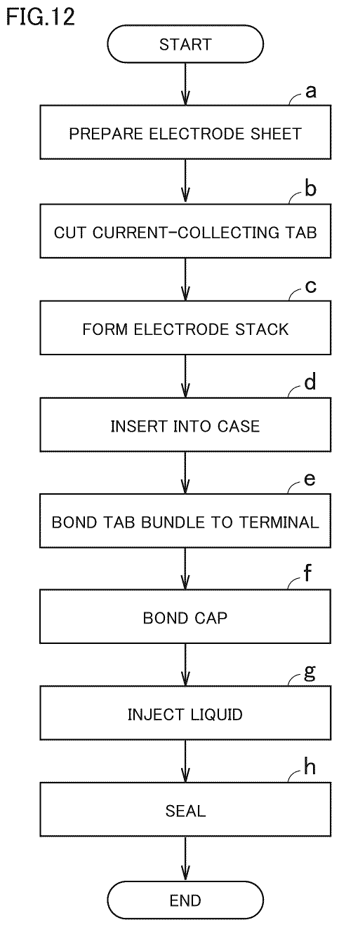

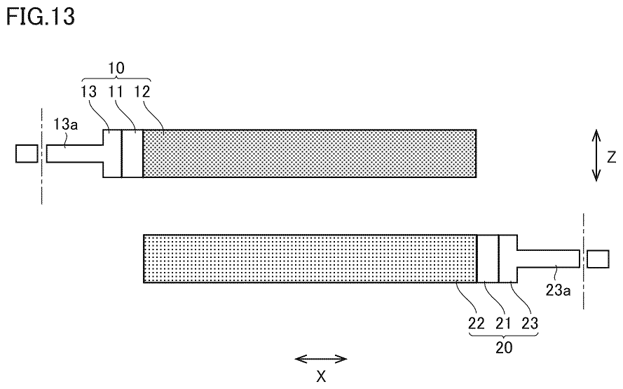

FIG. 12 is a schematic flowchart illustrating a method of producing a power storage cell according to the present embodiment. Hereinafter, “the method of producing a power storage cell according to the present embodiment” may be simply called “the present production method”. The present production method includes “(a) preparing an electrode sheet”, “(b) cutting a current-collecting tab”, “(c) forming an electrode stack”, “(d) inserting into a case”, and “(e) bonding a tab bundle to a terminal”. The present production method may further include “(f) bonding a cap”, “(g) injecting liquid”, “(h) sealing”, and the like, for example.

### (a) Preparing Electrode Sheet

The present production method includes preparing electrode sheets each having a current-collecting tab. For example, positive electrode sheet 10 and negative electrode sheet 20 illustrated in FIG. 7 or FIG. 8 may be prepared. A plurality of positive electrode sheets 10 may be prepared, and a plurality of negative electrode sheets 20 may be prepared.

### (b) Cutting Current-Collecting Tab

FIG. 13 is a schematic plan view illustrating an example of (b) cutting a current-collecting tab according to the present embodiment. The present production method includes cutting off a part of the current-collecting tab to adjust the length of the current-collecting tab. The length of a current-collecting tab refers to the dimension in the X direction. For example, a part of end part 13a may be cut off to adjust the length of positive electrode current-collecting tab 13. For example, a part of end part 23a may be cut off to adjust the length of negative electrode current-collecting tab 23. The cutting method is not particularly limited. For example, a cutting tool may be used. For example, a laser may be used to cut off a part of the current-collecting tab.

### (c) Forming Electrode Stack

The present production method includes forming electrode stack 50 having a tab bundle by stacking the electrode sheets together. For example, as illustrated in FIG. 3, FIG. 4, and the like, positive electrode sheet 10 and negative electrode sheet 20 may be stacked alternately to form electrode stack 50. Electrode stack 50 has positive electrode tab bundle 51 and negative electrode tab bundle 52. For example, as illustrated in FIG. 5, the present production method may include forming a tab bundle by tying the plurality of electrode tabs together.

In (b) above, the lengths of the current-collecting tabs are adjusted in advance. For example, a part of positive electrode current-collecting tab 13 may be cut off so that the lengths of the plurality of positive electrode current-collecting tabs 13 are different from one another at at least part of positive electrode tab bundle 51. For example, a part of negative electrode current-collecting tab 23 may be cut off so that the lengths of the plurality of negative electrode current-collecting tabs 23 are different from one another at at least part of negative electrode tab bundle 52.

For example, as illustrated in FIG. 3, a part of the current-collecting tab may be cut off so that the lengths of the current-collecting tabs decrease gradually in the stacking direction (the Y direction). For example, as illustrated in FIG. 4, a part of the current-collecting tab may be cut off so that a current-collecting tab that is the longest among the plurality of the current-collecting tabs is positioned at an intermediate position in the stacking direction (the Y direction).

### (d) Inserting into Case

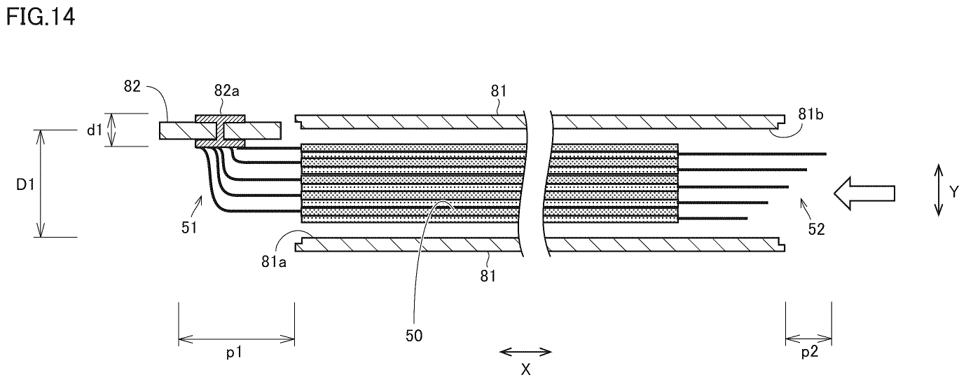

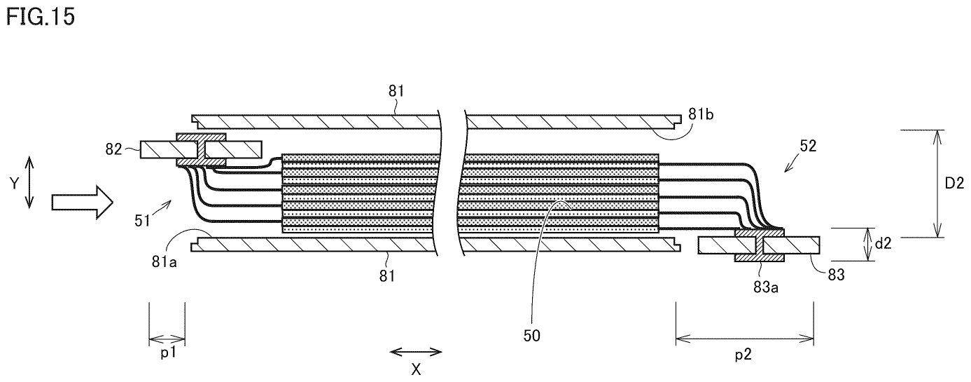

FIG. 14 is a first schematic cross-sectional view illustrating an example of (d) inserting into a case and (e) bonding a tab bundle to a terminal according to the present embodiment. The present production method includes inserting electrode stack 50 into case 80. For example, electrode stack 50 is inserted into case body 81 in a tubular shape. The direction (the X direction) that is orthogonal to the stacking direction of electrode stack 50 may be parallel to the axial direction of case body 81. Electrode stack 50 may be inserted from first opening 81a, or may be inserted from second opening 81b.

### (e) Bonding Tab Bundle to Terminal

The present production method includes bonding the tab bundle to an electrode terminal. Electrode stack 50 may be slid to reach a first position, for example. When it is at the first position, a first protruding portion p1 of positive electrode tab bundle 51 protruding from first opening 81a is larger in the X direction than a second protruding portion p2 of negative electrode tab bundle 52 protruding from second opening 81b. At the first position, positive electrode tab bundle 51 may be bonded to positive electrode terminal 82a. The bonding method is not particularly limited. For example, ultrasonic bonding, laser bonding, resistance welding, and/or the like may be adopted.

FIG. 15 is a second schematic cross-sectional view illustrating an example of (d) inserting into a case and (e) bonding a tab bundle to a terminal according to the present embodiment. After positive electrode tab bundle 51 and positive electrode terminal 82a are bonded together, electrode stack 50 may be slid in a direction opposite to a direction in which electrode stack 50 is inserted. Electrode stack 50 may be slid to reach a second position, for example. When it is at the second position, the second protruding portion p2 of negative electrode tab bundle 52 protruding from second opening 81b is larger in the X direction than the first protruding portion p1 of positive electrode tab bundle 51 protruding from first opening 81a. For example, when the relationship of “d1<D1” is satisfied, first cap 82 may be inserted into case body 81 together with electrode stack 50, and slid. At the second position, negative electrode tab bundle 52 may be bonded to negative electrode terminal 83a. The order of bonding is not particularly limited. Bonding may be carried out from the negative electrode side.

### (f) Bonding Cap

The present production method may include, for example, bonding a cap to case body 81. For example, as illustrated in FIG. 2, the posture of first cap 82 is adjusted so that first cap 82 can fit in first opening 81a. For example, the part where first cap 82 is engaged with case body 81 may be irradiated with a laser to bond first cap 82 and case body 81 to each other.

Inside case 80, positive electrode tab bundle 51 is accommodated in a curved state. For example, positive electrode tab bundle 51 may be folded. Positive electrode tab bundle 51 may be folded in the Y direction in a U-shape, for example. Positive electrode tab bundle 51 may be folded in the Y direction in a V-shape, for example. In the present production method, because a part of positive electrode current-collecting tab 13 is cut off, the volume of positive electrode tab bundle 51 is small. As a result, it is possible to fold positive electrode tab bundle 51 small. That is, energy density is expected to be enhanced.

Similarly, negative electrode tab bundle 52 may be accommodated inside the case. Second cap 83 may be bonded to case body 81.

### (g) Injecting Liquid, (h) Sealing

The present production method may include injecting an electrolyte solution (not illustrated) into case 80, for example. First cap 82 and second cap 83 are bonded to case body 81 to form case 80. For example, liquid inlet 84 may be provided to first cap 82. Through liquid inlet 84, the electrolyte solution may be injected into case 80. After injection of the electrolyte solution, liquid inlet 84 may be closed with a plug (not illustrated).

What is claimed is:

1. A power storage cell comprising:
a case; and
an electrode stack, wherein
the case accommodates the electrode stack,
the case includes a case body and a cap,
the case body has an opening,
the opening is closed by the cap,
the cap has an electrode terminal provided thereto,
the electrode stack is formed of a plurality of electrode sheets stacked together,
each of the plurality of the electrode sheets has a current-collecting tab,
the plurality of the current-collecting tabs are stacked together to form a tab bundle,
at at least part of the tab bundle, lengths of the plurality of the current-collecting tabs are different from one another,
the tab bundle is bonded to the electrode terminal, and
inside the case, the tab bundle is accommodated in a curved state.

2. The power storage cell according to claim 1, wherein the lengths of the current-collecting tabs decrease sequentially from an outer circumferential side of a curve of the tab bundle toward an inner circumferential side of the curve.

3. The power storage cell according to claim 1, wherein at an intermediate position between an outer circumferential side of a curve of the tab bundle and an inner circumferential side of the curve, a current-collecting tab that is the longest among the plurality of the current-collecting tabs is positioned.

4. The power storage cell according to claim 1, wherein
each of the plurality of the current-collecting tabs has a cut end face at a tip thereof closer to the electrode terminal, and
in a state where the tab bundle and the electrode terminal are separated from each other and each of the plurality of the current-collecting tabs is stretched in a length direction, the plurality of the cut end faces are not aligned with each other.

5. The power storage cell according to claim 1, wherein
the plurality of the current-collecting tabs are tied together to form the tab bundle,
each of the plurality of the current-collecting tabs has a cut end face at a tip thereof closer to the electrode terminal, and
in a state where the tab bundle is bonded to the electrode terminal, at a tip of the tab bundle, the plurality of the cut end faces are aligned with each other.

6. The power storage cell according to claim 1, wherein
the tab bundle includes a first tab bundle and a second tab bundle,
at at least part of the first tab bundle, the lengths of the plurality of the current-collecting tabs are different from one another,
at at least part of the second tab bundle, the lengths of the plurality of the current-collecting tabs are different from one another,
both the first tab bundle and the second tab bundle are connected to the same electrode terminal,
inside the case, each of the first tab bundle and the second tab bundle is curved,
the cap has a liquid inlet provided thereto, and
an axis of the liquid inlet lies between the first tab bundle and the second tab bundle.

7. The power storage cell according to claim 1, wherein when viewed in a plane, each of the plurality of the current-collecting tabs has an end part with a projected portion.

8. The power storage cell according to claim 1, wherein a thickness of the cap is smaller than a minimum diameter of the opening.

9. A method of producing a power storage cell, the method comprising:
(a) preparing electrode sheets each having a current-collecting tab;
(b) cutting off a part of the current-collecting tab to adjust a length of the current-collecting tab;
(c) forming an electrode stack having a tab bundle by stacking the electrode sheets together;
(d) inserting the electrode stack into a case; and
(e) bonding the tab bundle to an electrode terminal, wherein
the tab bundle is formed of the current-collecting tabs stacked together,
inside the case, the tab bundle is accommodated in a curved state, and
the (b) includes cutting off a part of the current-collecting tab so that the lengths of the plurality of the current-collecting tabs are different from one another at at least part of the tab bundle.

10. The method of producing a power storage cell according to claim 9, wherein the (b) includes cutting off the part of the current-collecting tab so that the lengths of the current-collecting tabs decrease sequentially from an outer circumferential side of a curve of the tab bundle toward an inner circumferential side of the curve.

11. The method of producing a power storage cell according to claim 9, wherein the (b) includes cutting off the part of the current-collecting tab so that a current-collecting tab that is the longest among the plurality of the current-collecting tabs is positioned at an intermediate position between an outer circumferential side of a curve of the tab bundle and an inner circumferential side of the curve.

12. The method of producing a power storage cell according to claim 9, wherein
as a result of cutting off the part of the current-collecting tab, a cut end face is formed, and
the (c) includes forming the tab bundle by tying the plurality of the current-collecting tabs together in a state where the current-collecting tabs are stacked together with the plurality of the cut end faces being aligned with each other.

13. The method of producing a power storage cell according to claim 9, wherein
the case includes a case body in a tubular shape, a first cap, and a second cap,
the case body has a first opening at one end in an axial direction and a second opening at the other end in the axial direction,
the first cap is configured to close the first opening,
the second cap is configured to close the second opening,
the first cap has a positive electrode terminal provided thereto,
the second cap has a negative electrode terminal provided thereto,
the electrode stack includes a positive electrode tab bundle and a negative electrode tab bundle,
in an orthogonal direction that is orthogonal to a stacking direction of the electrode sheets, each of the positive electrode tab bundle and the negative electrode tab bundle protrudes outwardly,
in the orthogonal direction, the negative electrode tab bundle and the positive electrode tab bundle protrude in opposite directions,
the electrode stack is inserted in the case body in such a manner that the orthogonal direction lies parallel to the axial direction, and
the positive electrode terminal is bonded to the positive electrode tab bundle to achieve a positional relationship where a protruding portion of the positive electrode tab bundle protruding from the first opening is larger in the axial direction than a protruding portion of the negative electrode tab bundle protruding from the second opening.

14. The method of producing a power storage cell according to claim 13, wherein
after the positive electrode tab bundle and the positive electrode terminal are bonded together, the electrode stack is slid in a direction opposite to a direction in which the electrode stack is inserted, and
the negative electrode terminal is bonded to the negative electrode tab bundle to achieve a positional relationship where the protruding portion of the negative electrode tab bundle protruding from the second opening is larger in the axial direction than the protruding portion of the positive electrode tab bundle protruding from the first opening.
